(19) United States
(12) Patent Application Publication
(10) Pub. No.: US 2006/0199751 A1
(43) Pub. Date: Sep. 7, 2006

(54) Supplemental ozone treatment methods for difficult cleaning and sterilizing applications

(76) Inventor: Terrence R Langford, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/552,879

(22) PCT Filed: Apr. 18, 2003
(86) PCT No.: PCT/US03/12027

§ 371 Date: Oct. 12, 2005

(51) Int. Cl. C11D 3/395

(52) U.S. Cl. 510/302

(57) ABSTRACT

Methods of treating soiled items, such as medical instruments, with supplemental ozone treatment, such as combinations of ozone and one or more cleaning agents or sterilants, are provided. The methods involve treating soiled items with ozone to facilitate cleaning, ensure complete sterility, and degrade residual chemical agents, such as sterilants or cleaning agents, from both the instrument and wash/rinse effluent. By treating an item with ozone in a supplemental wash or rinse in cooperation with one or more other chemicals used to clean and sterilize the item, one can ensure that the item and effluent are free of soiling, infectious agents, and chemical residues while minimizing any oxidation-related damage to the item or pollution of the environment.

### BACKGROUND OF THE INVENTION

1. Field of the Invention

This invention relates generally to methods used both to clean items and to ensure that cleaned items are substantially free of biological and/or chemical contaminants and more particularly to methods that are especially useful to ensure the sterility of tubular medical items such as endoscopes.

2. Description of the Related Art

The cleaning and decontamination of items that come into contact with the bodily substances of people or animals such that they are substantially “substance free” (of, e.g., viruses, bacteria, detergent, sterilant, lipids, etc.) represent an immense and ongoing challenge. This challenge has been underscored by a recent article entitled “Widely used sterilizer under attack” (published in Jan. 21, 2003 edition of the newspaper USA Today). The article describes a fatal outbreak of bacterial infection that was linked to the improper sterilization of hospital bronchoscopes. Despite the hospital's use of one of the most popular sterilizing systems, tests performed by the Centers for Disease Control and Prevention found bacteria on the system's water filters and in its rinse water. This and other infection outbreaks has led to continuing controversy over how best to clean and sterilize used endoscopes.

The contaminants typically found on tubular medical items, such as endoscopes, are especially difficult to remove. In addition to fecal mater, loose cellular debris, blood and blood products, viruses, and bacteria, an endoscope can be coated with various hydrophobic films, such as “biofilm” material. A biofilm typically comprises cells, both dead and alive, cell debris and extracellular polymer substances. Once biofilm is formed by microorganisms (including bacteria, fungi, and protozoans), these microorganisms can colonize and replicate on the interior surfaces of tubing, forming a protective slime layer known as a “glycocalyx” that is especially difficult to remove.

Merely soaking endoscopes in a sterilant or detergent is unacceptable since numerous pockets exist within the tubing where the sterilant or detergent cannot reach effectively, which leaves areas of contamination within the endoscope. Moreover, with the prevalence of highly contagious diseases such as hepatitis B and Acquired Immune Deficiency Syndrome, reliable sterilization or disposal of all used medical tools seemingly becomes mandatory. Yet, while many medical instruments today are routinely cleaned, disinfected, and reused, experts in the field recently have warned that some of the more difficult to clean and sterilize medical items are putting people at risk.

Indeed, one expert has stated that there are no independent published reports or data anywhere in the medical literature that show liquid chemical sterilants (or any other method/process/agent) can be used to reliably “sterilize” flexible endoscopes or other complex, lumened instruments (See Comments by L. Muscarella (Custom Ultrasonics) on AAMI TIR7:1999, Chemical Sterilants and Sterilization Methods: A Guide to Selection and Use, downloaded from the website myendosite.com).

To the contrary, Kovacs et al. reports that a strain of Pseudomonas aeruginosa has been repeatedly isolated from tap water used for cleaning and rinsing endoscopes and appears to be responsible for three separate clinical episodes of endoscopic retrograde cholangio-pancreatography (ERCP)-associated cholangitis over an 11-yr period. These authors also conclude that the organism is resistant to a commonly used sterilant because it was recovered from a variety of endoscopes that had undergone stringent reprocessing protocols (see Kovacs B J, et al. “Efficacy of various disinfectants in killing a resistant strain of Pseudomonas aeruginosa by comparing zones of inhibition: Implications for endoscopic equipment reprocessing,” Am J Gastroenterol 1998;93:2057-9). Thus, there is a genuine need for “overkill” sterilization to help ensure that even chemical-resistant pathogens are effectively eliminated.

In addition to the infection issues, environmental concerns over the content of medical item wash or rinse water effluent have become more pronounced as the detrimental effects (including toxicity) of various cleaning and sterilizing chemicals are now better understood. For example, commonly used liquid chemical sterilants, such as glutaraldehyde and paracetic acid, are known to have adverse health effects or carcinogenic activity. Since most endoscope cleaning and sterilization is accomplished with various detergents in combination with glutaraldehyde or paracetic acid, harmful chemical residue can be left behind both on the item and in the wash or rinse effluent Therefore, discharge of these chemicals into rivers, lakes, and even sewer systems raises safety issues that have yet to be addressed.

Furthermore, some chemical cleaners or sterilants are so harshly reactive that they can damage the items they are meant to clean or sterilize. Thus, the problems encountered during item (and especially medical item) cleaning and disinfecting primarily involve trying to strike a balance between ensuring as much as possible the complete removal of contaminants and chemicals while, at the same time, not damaging the instrument or the environment.

Even the simple act of rinsing medical items with filtered water after cleaning or sterilization has been called into question. After sterilization, endoscopes typically are rinsed with water filtered down to the 0.2 micron (200 nanometer) level. Unfortunately, many viruses, endotoxins, and prions are smaller than 200 nanometers, meaning that they can remain in the water even after filtration Also, as reported in the articles mentioned above, water and water filters are known sources of contamination. Even more troubling, however, is the statement by one expert that “there are no independent data in the medical literature that support the production of sterile water (defined as containing fewer than 10⁻⁶ CFU/ml and fewer than 5 endotoxin units/ml) by passing unprocessed water (that is, un-sterilized water, such as water that flows though a hospital's tap) through abacterial (e.g., 0.1 or 0.2 micron) filtration system” (See Comments by L. Muscarella (Custom Ultrasonics) on AAMI TIR7:1999, Chemical Sterilants and Sterilization Methods: A Guide to Selection and Use, downloaded from the website myendosite.com). Moreover, there is no currently available system that monitors the biological content of filtered water to insure its sterility when used in conjunction with medical item cleaning or sterilization apparatuses. Finally, having to add additional sterilization steps and/or use sterilized (e.g., autoclaved) water becomes tedious and expensive.

Ozone is a well known sterilant. Ozone was first used for drinking water treatment in 1893 in the Netherlands. While being used frequently in Europe for drinking water disinfection, it was slow to transfer to the United States. Indeed, early application of ozone for water treatment in the United States was primarily for non-disinfection purposes such as color removal or taste and odor control. Today, ozone also is known to oxidize oils and reduce scale build-up. Nonetheless, the strongly oxidative qualities of ozone also present problems in that the use of ozone for the cleaning and disinfecting of items will often result in permanent damage to the item, especially if it is exposed to ozone for long periods while attempting to completely clean and decontaminate all surfaces.

Thus, while ozone applications to water and water line disinfection are now fairly common, these methods have not become widespread in other sterilization applications because they rely on a treatment system that reticulates ozonated water through the entire treatment area during repeated cleaning cycles in order to achieve and maintain disinfection. Such constant treatment is not possible for most items (and especially medical items) due to the damage that continual or repeated exposure to ozone would cause.

Even with recent advances in cleaning devices and methods, such as those invented by Langford (see, for example, U.S. Pat. No. 5,443,801), there still remains the problem of balancing the need for complete cleaning, disinfection, and degradation of all chemical residues on an item with preventing or mitigating damage to that item and to the environment.

Therefore, there continues to be a need for a cleaning and decontaminating method that, without damaging the item being treated, helps to ensure sterility, assists in loosening difficult soiling, such as biofilm-entrained contaminants and other hydrophobic compositions or films, and degrades chemicals so that effluent is substantially free of harmful residues.

### SUMMARY OF THE INVENTION

The invention generally involves a method of synergistically treating soiled items, such as medical instruments, with ozone and/or combinations of ozone with one or more cleaners or sterilants as a supplement to conventional cleaning/sterilization regimens. Ozone or ozonated fluids are not used as a primary (or sole) cleaning or sterilizing agent. Instead, ozone is used as a secondary or supplemental agent to (1) facilitate cleaning, (2) prevent re-contamination, and (3) degrade residual chemical agents, such as sterilants or detergents, from both the instrument and the wash/rinse effluent.

The general concept is that treating an item with ozone as a supplemental initial, intermediate, and/or final treatment step, in cooperation with one or more other chemicals used to clean and sterilize the item, ensures that the item and effluent are free of soiling, infectious agents, and chemical residues without causing any oxidation-related damage to the item. Moreover, given the recent focus on the need to provide an “overkill factor” to prevent re-contamination of endoscopes and medical item processing equipment, the invention provides for the ozonation of filtered (or unfiltered) rinse water commonly used in existing sterilization systems.

An added point of novelty of this invention is that supplemental ozone treatment facilitates the use of very effective yet non-preferred cleaning agents and sterilants. For example, the European Union and Australia have recommended against the use of glutaraldehyde for sterilizing endoscopes due to pollution and exposure-based heath concerns. By adding ozone treatment to the end of the glutaraldehyde sterilization process, harmful chemical residue is degraded. Moreover, the use of ozone in combination with other chemical cleaning or sterilizing agents before, during, or after the cleaning and sterilizing process produces a synergistic effect. That is to say, adding ozone treatment to other cleaning and sterilizing treatments produces markedly improved results while minimizing oxidation damage and chemical pollution. Another benefit is that the other chemicals can be used in lesser amounts.

Accordingly, in one embodiment of the invention, a method of using ozonated fluid is provided as a “pre-rinse” to solubilize hydrophobic residue (e.g., biofilm deposits), thereby making the cleaning/sterilizing process more efficient. In other words, the invention involves a new and improved method of using ozone as a “pre-rinse” to loosen soil such that further cleaning and sterilizing would be more effective. Preferably, the item to be cleaned or sterilized is pre-rinsed by having ozonated fluid pass back-and-forth over the exterior and through any openings in the item. In another embodiment, a “final rinse” of a medical item is made with ozone to prevent re-contamination and to degrade chemical sterilant and cleaning chemical residue on the item and in the effluent, thus allowing the discharge of the same into the sewer. Still other embodiments feature co-treatments of ozone and cleaning or sterilizing agents.

Thus, it is a primary objective of the invention to provide a medical item cleaning method that improves cleanliness and ensures sterility while rendering the effluent substantially harmless.

Further, an object of the invention is to provide a cleaning method that effectively utilizes ozone while minimizing damage to the item being cleaned.

Yet another object of the invention is to provide a cleaning method that is adaptable for use in supplementing currently existing cleaning methods.

An additional object of the invention is to provide a cleaning method that is economical and inexpensive to utilize.

Still another object of the invention is to provide a cleaning and sterilizing method that may be used in conjunction with a wide variety of cleaning or sterilizing apparatuses.

Yet another object of the invention is to provide a method for ensuring the sterility of water used to rinse endoscopes or other items after cleaning and sterilization have taken place.

A further object of the invention is to provide of method of preventing re-contamination through the use of ozone of equipment that processes used medical items, assuring, for example, that any trays, ports, and chambers of such equipment are kept sterile.

In accordance with these and other objects, there is provided a new and improved ozone treatment method that utilizes supplemental pre-treatments, co-treatments, and/or final rinses with ozone or water that has been ozonated. The method is especially useful in the treatment of water entering an apparatus used to clean and/or sterilize a medical item to provide an “overkill” effect that prevents re-contamination of the item, the apparatus, and/or a water filter used therewith.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### DETAILED DESCRIPTION OF THE PREFERRED EMBODIMENTS

The invention relates generally to a method of treating soiled items that combines ozone treatment with cleaning and/or sterilizing treatments involving one or more chemical agents. In other words, ozone is not used as a primary cleaning or sterilizing agent, but, rather, ozone treatment is provided only to supplement other cleaning/sterilizing agents.

Thus, the problems associated with ozone use (e.g., oxidative damage) are overcome while beneficial results are produced.

The synergistic effects produced by combining ozone with other chemical treatment regimens greatly increases cleaning and sterilizing options. For example, effective cleaning and sterilizing substances that currently are not widely used due to health and pollution concerns can now be utilized because virtually any chemical will be degraded when exposed to ozone. The synergistic benefits of providing ozone treatment with other chemical agents also extend to difficult cleaning applications. Indeed, one of the main problems with cleaning agents in use today is that they do not efficaciously remove the “greasy residue,” such as cellular lipids, fat particles, or biofilm. However, despite the industry-wide reservations to ozone use (due to the damage prolonged exposure can cause to medical items), the inventor has discovered that ozone treatment in combination with existing cleaning and sterilizing methods can solve this and other problems in order to advance the methods of the art.

Accordingly, in some embodiments of the invention, ozone is used as a “pre-soak” or “pre-rinse” to help break down or loosen soil, such as proteins, lipids, or other hydrophobic biomatter. In other embodiments, combinations of ozone with cleaning agents are used to clean and degrade contaminants and chemical residue. In still other embodiments, an item is first cleaned using, for example, a detergent. Afterwards, a sterilant is applied and then removed with a rinse of ozone (e.g., ozonated water) washed over and through the endoscope in preparation for subsequent use with a patient. Still another embodiment involves treating rinse water with ozone to prevent re-contamination of the item.

Within this discussion, endoscopes will be used as an example of an item or instrument to be cleaned. However, the invention is not intended to be limited to this one type of item. Rather, the inventor contemplates use of the invention with any tubular item as well as a variety of other items such as circuit boards, medical instruments, dental instruments, and other items in which reliable cleaning and/or sterilization is required.

Ozone exists as a gas at room temperature. The gas is colorless with a pungent odor readily detectable at concentrations as low as 0.02 to 0.05 ppm (by volume), which is below concentrations of health concern. Ozone is a powerful oxidant, second only to the hydroxyl free radical, among chemicals typically used in disinfecting treatments. Therefore, it is capable of oxidizing (and thereby damaging) many organic and inorganic compounds used in medical items, such as endoscopes.

Ozone is sparingly soluble in water. At 20° C., the solubility of pure ozone is only 570 mg/L. Ozone concentrations used in water treatment are typically below 14 percent, which limits the mass transfer driving force of gaseous ozone into the water. Consequently, typical concentrations of water-soluble ozone range from <0.1 to 1 mg/L, although higher concentrations can be attained under optimum conditions.

Basic chemistry research has shown that ozone decomposes spontaneously in water by a complex mechanism that involves the generation of hydroxyl free radicals. The hydroxyl free radicals are among the most reactive oxidizing agents in water, with reaction rates on the order of 1010-1013 M⁻¹ s⁻¹, approaching the diffusion control rates for solutes such as aromatic hydrocarbons, unsaturated compounds, aliphatic alcohols, and formic acid. On the other hand, the half-life of hydroxyl free radicals is on the order of microseconds. Therefore, concentrations of hydroxyl free radicals can never reach levels above 10-12 M.

Chemically speaking, ozone can react either by direct oxidation of compounds by molecular ozone (O₃(aq)) or by oxidation of compounds by hydroxyl free radicals produced during the decomposition of ozone. The two oxidation pathways compete for substrate (i.e., compounds to oxidize). The direct oxidation with aqueous ozone is relatively slow (compared to hydroxyl free radical oxidation) but the concentration of aqueous ozone is relatively high. On the other hand, the hydroxyl radical reaction is fast, but the concentration of hydroxyl radicals under normal ozonation conditions is relatively small.

Under acidic conditions, the direct oxidation with molecular ozone is of primary importance; and under conditions favoring hydroxyl free radical production, such as high pH, exposure to UV, or addition of hydrogen peroxide, the hydroxyl oxidation starts to dominate. The spontaneous decomposition of ozone occurs through a series of steps. The exact mechanism and reactions associated have not been established, but mechanistic models have been proposed. It is believed that hydroxyl radicals form as one of the intermediate products, and can react directly with compounds in the water. The decomposition of ozone in pure water proceeds with hydroxyl free radicals produced as an intermediate product of ozone decomposition, resulting in the net production of 1.5 mole hydroxyl free radicals per mole ozone.

Because ozone is an unstable molecule, it should be generated at the point of application. It is generally formed by combining an oxygen atom with an oxygen molecule. This reaction is endothermic and requires a considerable input of energy. Ozone can be produced several ways, although one method, corona discharge, predominates in the ozone generation industry. Ozone can also be produced by irradiating an oxygen-containing gas with ultraviolet light, electrolytic reaction and other emerging technologies. Most ozone generators currently use ultraviolet radiation. These are usually the lowest cost ozone generators on a per unit basis. This decrease in cost is due to the fact that the air does not go through an initial drying process.

Newer units being produced utilize a corona discharge technique which dry the air before charging the air with ozone. This drying permits the corona discharge apparatus to produce a higher ozone concentration. For minimal expenditures of electrical energy, ozone normally is produced from dried air (−60 degrees Fahrenheit dew point) in concentrations of one to two percent and from dry oxygen in concentrations of two to four percent. More than eighty percent of the electrical energy applied to the electric discharge field is converted to heat and, if this is not quickly removed from the cell, the heat causes rapid decomposition of the ozone back to oxygen. For additional guidance in ozone production and its uses, see U.S. Pat. No. 5,207,237.

For cleaning or sterilizing methods involving the use of ozone, it is important to recognize that the time of exposure and concentration of ozone will vary based on a number of parameters, such as the quantity and size of items being treated, the volume of the cleaning or sterilizing apparatus, and the nature and amount of “soil” on and in the item. Preferably, ozonated water is used to treat items for 5-30 minutes at a concentration of 1-10% ozone by volume.

In terms of checking the progress of ozone-assisted cleaning, existing standards used for monitoring cleaning efficacy before passing from the wash/rinse cycle of a given cleaning apparatus would be chosen to meet the standards of the time or the situation. The preferred standard is set forth by the Food and Drug Administration, including flow-rate and size of particles found in Particulate Matter in Injections, commonly known as USP 788 Specification.

A number of known cleaning and sterilization methods are readily available. Some are performed in automatic endoscope reprocessors, while others are done manually. For example, Yale Medical School recommends that an endoscope can be manually cleaned by placing the distal end of the endoscope into an enzymatic detergent solution followed by applying suction to the solution through the biopsy/suction channel until the solution is visibly clean. One then alternates the suctioning of clean detergent solution with air several times, followed by removing the air under vacuum (further details are available online at Yale's Internet website info.med.yale. edu/ynhh/infection/steril/standards). To supplement this cleaning method, ozonated water (2% by volume) could be used to pre-rinse (preferably, by moving the ozonated water over and through the endoscope continuously) for 5 minutes before the washing protocol is implemented in order to loosen the soil in and on the endoscope. Alternatively, five minutes of ozonated water washing could be substituted for the final “clean detergent solution” rinse to degrade residual detergent before sterilization commences.

The following additional examples are meant to further illustrate, but not to limit, the invention.

### EXAMPLE 1

1. Purpose

The purpose of this test is to document the results of engineering characterization testing performed on a automatic endoscope reprocessor, the Langford I. C. Systems Sterilizer Cleaner (see U.S. Pat. No. 5,906,802 for layout and guidance in the use of this reprocessor). This test is intended to determine that a test lumen scope is clean by visual inspection only (Example 2 describes a test to quantify the level of sterility).

2. Scope

This test seeks to describe methods and test results for cleaning efficacy of individual and combined cycle phases on mock devices used to simulate a colonoscope. Testing was performed on DWGX-0129-01888, Cleaner, Sterilizer Breadboard.

3. Equipment and Calibration

4.1 EQP-0129-0001, Thermocouple Omega Model HH21 Type J, K, T.

4.2 Birmingham simulated respiratory tract soils

4.3 Hucker's simulated fecal soil

4.4 SIMPLE GREEN cleaner (Sunshine Makers, Inc)

4.5 LESTOIL concentrated cleaner (The Clorox Company)

4.6. Digital camera

4.7 250 ml plastic graduated cylinder

4.8 Device under test

a. DWGX-0129-01888, Cleaner Sterilizer Apparatus Breadboard

b. DWGX-0129-01889, Mock Colonoscope Assy

5. Test Description

Testing was conducted to determine initial parameter settings necessary for effective cleaning of Birmingham soil and Hucker's soil from mock scope and simulated scope lumens. The scope lumens and mock scope were inoculated with either the Birmingham soil or the Hucker's soil (at a level that is 100× the level of soiling required FDA test standards) and left sitting for a one hour time period to permit some drying. In this test, we determined cleaning effectiveness by visual inspection only. This was done by running the Sterilizer Cleaner machine with varying baffle configurations, temperatures, cleaners (type and quantity), speed and time.

After a test was completed, the resulting pressure was recorded on the log sheet along with test results. Depending on the effectiveness of the first cycle of the test a second clean cycle was run to show the mock lumen or mock scope was clean by visual inspection. Other times a first clean cycle was run and a second rinse (water only) cycle was run to further clean the test lumen or scope. After the test Lumen or scope was clean by visual inspection, a digital picture was taken and stored for future reference. The test lumen then was bagged and tagged and stored for future reference.

6. Test Results and Conclusions

The Langford I. C. Systems Sterilizer Cleaner performed effectively at cleaning out both Birmingham soil and Hucker's soil from the exterior and the interior of mock lumens and the mock scope. The two cleaning agents were used and seemed to be equally effective. The Langford I. C. Systems Sterilizer Cleaner performed effectively at pressures as little as 4 psi and at temperatures as low as 110° F. for washes or rinses of as little as 5 minutes in length. The preferred rate of “liquid displacement” (i.e., the back-and-forth liquid cycling rate in the item-washing chamber of the Sterilizer Cleaner) is 1 gallon per 2 seconds. Based on these results, a number of different cleaning protocols may be used successfully. One preferred protocol involves using 250 ml of SIMPLY GREEN detergent to wash the endoscope for 5 minutes at 110° F. and 5 psi on the 1 gallon/2 seconds liquid-displacement setting, followed by a water rinse at the same temperature and pressure.

7. Supplement: Adding Ozone Treatment

a. Prior to the first cleaning cycle with a detergent, the mock scopes are exposed to ozonated water (4% by volume) at a liquid-displacement rate of 1 gallon/2 seconds for 5 minutes to loosen soil. The ozone is generated by corona discharge and added to water in the chamber fill line thru a Mazzei venturi injector at a rate of 1.25 g/hr at 5 SCFH dry air flow (per an 11 gallon system, but can be adjusted for other volumes). After ozone exposure, the scopes are cleaned using 250 ml of SIMPLY GREEN detergent and washing for 5 minutes at 110° F. and 5 psi on the 1 gallon/2 second liquid-displacement setting, followed by a water rinse at the same temperature and pressure.

b. After the cleaning cycle is complete, the rinse water is ozonated by corona discharge as described above in step a The mock scopes are then rinsed with the treated water for 5 minutes to degrade any residual detergent.

### EXAMPLE 2

The biopsy lumen of three colonoscopes were loaded with Hucker's Soil (100× more than required by FDA test standards) and inoculated with pathogens from an American Society of Test Methods kit. The scopes were left sitting for a 24 hour time period to permit some drying. Using the same Langford I. C. Systems Sterilizer Cleaner liquid-displacement settings as in Example 1, each colonoscope was subjected to one detergent wash at 4 psi for 10 min with 250 ml of SIMPLE GREEN cleaner in 10 liters of water followed by three 5 min rinses with 10 liters of filtered tap water. For the last (third) rinse, ozone generated by corona discharge was added to the water thru a Mazzei venturi injector connected to the incoming water line of the Langford reprocessor apparatus. The ozone was added to the water at a rate of 1.25 g/hr at 5 SCFH dry air flow.

Tests performed to quantify the level of decontamination on the three mock scopes used in this example indicated that two of the scopes showed a log 10⁻⁵ pathogen kill (indicating high level disinfection) while one scope had log 10⁻⁶ pathogen kill (indicates sterility). Visual inspection revealed no apparent damage to any endoscope surface.

Especially given the extremely high level of soiling, these results are much better than has previously been achieved for any known cleaning/disinfecting protocol, which typically results in a log 10⁻⁴ pathogen kill or less. Hence, supplementing existing endoscope reprocessing methods with ozone treatment results in a quantitative difference in decontamination without damage to the endoscope.

### EXAMPLE 3

In this example, a partitioned cleaning and sterilizing device of the type described and illustrated in U.S. Pat. No. 5,711,921 is utilized. The endoscope is positioned to extend through the partition such that one opening of the endoscope lies in one chamber and another opening of the endoscope lies in the other chamber. The partition between the chambers need not be an absolute partition and, in this example, the partition fits loosely around the endoscope so that as the medium (i.e. a liquid detergent, sterile water, a liquid sterilant, or a sterilant gas) surges from one chamber to the other, the medium washes over the exterior of the endoscope and simultaneously sweeps through the interior of the endoscope. The device creates this “surge” through the use of one or more flexible membranes. By deforming the flexible membrane (inward and outward), a pressure or suction is created which results in a flow (liquid displacement) between the chambers to equalize the pressure between them.

250 ml of detergent is added to 10 liters of water and is used to wash the endoscope for 10 min. The scope is then rinsed twice for 5 minutes each with 10 liters of filtered tap water. After the last water rinse, 10 liters of a liquid chemical sterilant (preferably 1 ounce paracetic acid per 5 liters of water) are added to the cleaner/sterilizer and the endoscope is washed for 5 minutes. Those of ordinary skill in the art readily recognize various other sterilants which can be used in this context.

In order to degrade any sterilant residue and to provide a final “overkill” treatment to prevent re-contamination of the endoscope (and the filter, cleaning chamber, or ports of the reprocessor equipment) by the filtered water, a final rinse with 10 liters of water ozonated at 1 g/hr at 5 SCFH dry air flow is performed for 5 minutes. Alternatively, the overkill treatment with ozonated water is provided by ozonated, filtered water stored in tank. The ozone is continuously added to the water in the tank by re-circulation past the venturi. Thus, the sterility of the water is ensured without exposing the reprocessor components or items to be cleaned to a constant supply of freshly generated ozone.

It should now be readily understood that ozone or an ozonated fluid could be used prior to, concurrent with, or after the cleaning steps described in order to improve cleaning and/or breakdown the detergent. Likewise, ozone or an ozonated fluid could be applied prior to, concurrent with, or after a chemical sterilant. Preferably, at least the final rinse water used in any protocol should be ozonated at the point of application to prevent re-contamination of the cleaned and sterilized item. This is especially true if the sterilization method relies on the use of filtered tap water.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products. All references cited in this application are hereby incorporated by reference herein.

1-13. (canceled)

14. A method of supplementing a cleaning and sterilizing process for a soiled item having bio-contaminants, comprising the steps of:
a. pre-rinsing said soiled item with ozone to loosen the soil,
b. applying a cleaning agent to the soiled item,
c. cleaning said soiled item until a clean item is produced,
d. applying a chemical sterilizing agent to said clean item to achieve high-level disinfection,
e. rinsing the high-level disinfected item with water; and
f. rinsing the high-level disinfected item with ozone to substantially degrade any remaining chemical residue and biomatter on or in said disinfected item.

15. The method of claim 14, wherein said soiled item comprises an endoscope.

16. The method of claim 14, wherein ozone comprises an ozonated liquid.

17. The method of claim 16, wherein said ozonated liquid includes between 0.1 and 15 percent ozone by volume.

18. The method of claim 14, wherein said soil comprises biofilm.

19. The method of claim 14, wherein step b additionally comprises applying ozone in combination with said cleaning agent.

20. The method of claim 14, wherein said chemical sterilizing agents are selected from the group consisting of glutaraldehyde, paracetic acid, and ethylene oxide.

21. A method of preventing re-contamination of a cleaned and high-level disinfected item, comprising:
a. rinsing said cleaned and high-level disinfected item with water; and
b. flushing said item with ozone.

22. The method of claim 21, wherein said item is an endoscope.

23. The method of claim 21, wherein said water is filtered tap water.

24. The method of claim 21, wherein the flushing of said item with ozone is achieved by ozonating said water.

25. The method of claim 21, wherein said item is contained within a cleaning or sterilizing apparatus when step b occurs.

26. The method of claim 25, wherein ozone is added to the water prior to the water entering the cleaning or sterilizing apparatus containing said item.

27. A method of preventing cross-contamination of components within a sterilizing apparatus, comprising:
a. high-level disinfecting an item placed within said sterilizing apparatus according to a predetermined method; and
b. flushing said components with ozone after the completion of step a.

28. The method of claim 27, wherein said components comprise a chamber, a filter, a tray, and a port.

29. The method of claim 27, wherein said components comprise fill lines.
